(19) United States
(12) Patent Application Publication
(10) Pub. No.: US 2017/0083542 A1
(43) Pub. Date: Mar. 23, 2017

(54) MULTI-VARIABLE SIGNATURE VERIFICATION

(71) Applicant: Biometrics Technology International Inc., San Diego, CA (US)

(72) Inventors: Thomas Harry Roskowick, Laguna Niguel, CA (US); Eric S. Emerson, Chester, NH (US); Dwayne Jeffrey, Merrimack, NH (US)

(21) Appl. No.: 14/860,595

(22) Filed: Sep. 21, 2015

(51) Int. Cl. G06F 17/30

(52) U.S. Cl. CPC G06F 17/30256; G06F 17/30371

(57) ABSTRACT

A database accesses data encapsulating an electronic representation of a signature. The electronic representation includes coordinates that represent the signature. The coordinates include pixel positions on an input device. Data is added to an initial group in the database. An analysis program determines, based on the coordinates, that the data is to be added to a reference cluster in the database. The data added represents a verified signature and the reference cluster is a subset of the initial group. The data is added by the analysis program to the reference cluster based on the determining.

### TECHNICAL FIELD

The subject matter described herein relates to signature verification and, in particular, to the verification of electronically recorded signatures.

### BACKGROUND

In the digital age, electronic signing either for access to a system or to show proof of an act, for example making a purchase, has become commonplace. For digital signatures, the position of a stylus, finger, or other signing tool or digital impressions made therefrom can be recorded and retained as an electronic copy of the signature.

### SUMMARY

In one aspect, a database accesses data encapsulating an electronic representation of a signature. The electronic representation includes coordinates that represent the signature. The coordinates include pixel positions on an input device. Data is added to an initial group in the database. An analysis program determines, based on the coordinates, that the data is to be added to a reference cluster in the database. The data added represents a verified signature and the reference cluster is a subset of the initial group. The data is added by the analysis program to the reference cluster based on the determining.

In some variations one or more of the following features can optionally be included in any feasible combination.

The database can access test data encapsulating a second electronic representation of a test signature. The second electronic representation can include test coordinates that represent the test signature. The database can compare the test data to the reference cluster. The database can transmit results data indicating acceptance or denial of the test signature based on the comparison.

The determination of data that is to be added to the reference cluster can also include, for a first signature, adding first data encapsulating a first electronic representation of the first signature to the initial group based on a comparison between the first data and a range of acceptable parameters. Also, for each signature accessed, subsequent to the first, subsequent data can be added that encapsulates a subsequent electronic representation of the subsequent signature to the initial group based on a comparison between the subsequent data and a subsequent range of acceptable parameters. The subsequent range of acceptable parameters can be based at least on the initial group.

The coordinates can include a number of time entries associated with pixel positions, wherein the time entries can correspond to times of recordation of the pixel positions.

The determination of data that is to be added to the reference cluster can further include (i) calculating an average difference for each pair of the signatures in the initial group. The average difference is the difference between the coordinates corresponding to the signatures. Also, (ii) calculating a mean average difference for each signature in the initial group, (iii) calculating a standard deviation of the average differences, (iv) calculating, based on the standard deviation of the average differences, a minimum value and a maximum value, and (v) adding the signature to the reference cluster based on the mean average difference being between the minimum value and the maximum value.

The database can access test data encapsulating a second electronic representation of a test signature. The second electronic representation can include test coordinates that represent the test signature. An average test difference can be calculated for each signature in the reference cluster. The average test difference can be a difference between the coordinates corresponding to the test signature and each of the signatures in the reference cluster. A mean average test difference between the test signature and each of the signatures in the reference cluster can be calculated.

The test signature can be accepted as a verified test signature if the mean average test difference is between the minimum value and the maximum value. Results data can be transmitted indicating acceptance or denial of the test signature based on the comparing.

Implementations of the current subject matter can include, but are not limited to, methods consistent with the descriptions provided herein as well as articles that comprise a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a computer-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

Implementations of the current subject matter can provide one or more advantages. For example, signatures can be verified using an arbitrary number and type of metrics, for example, pixel coordinates, time entries, pressure, etc. Statistical methods can be used to determine a representative group of signatures to be used for making comparisons with test signatures.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to multi-variable signature verification, it should be readily understood that such features are not intended to be limiting. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 is an exemplary diagram illustrating aspects of a signature verification system;

FIG. 2 is an exemplary process flow diagram illustrating the determination of signatures to be added to a reference cluster comprised of signatures;

FIG. 3 is an exemplary process flow diagram illustrating the verification of a test signature against a reference cluster comprised of signatures;

FIG. 4 is an exemplary diagram illustrating a screen capture showing recordation of the signatures; and

FIG. 5 is an exemplary process flow diagram illustrating the establishment of the reference cluster.

When practical, similar reference numbers denote similar structures, features, or elements.

### DETAILED DESCRIPTION

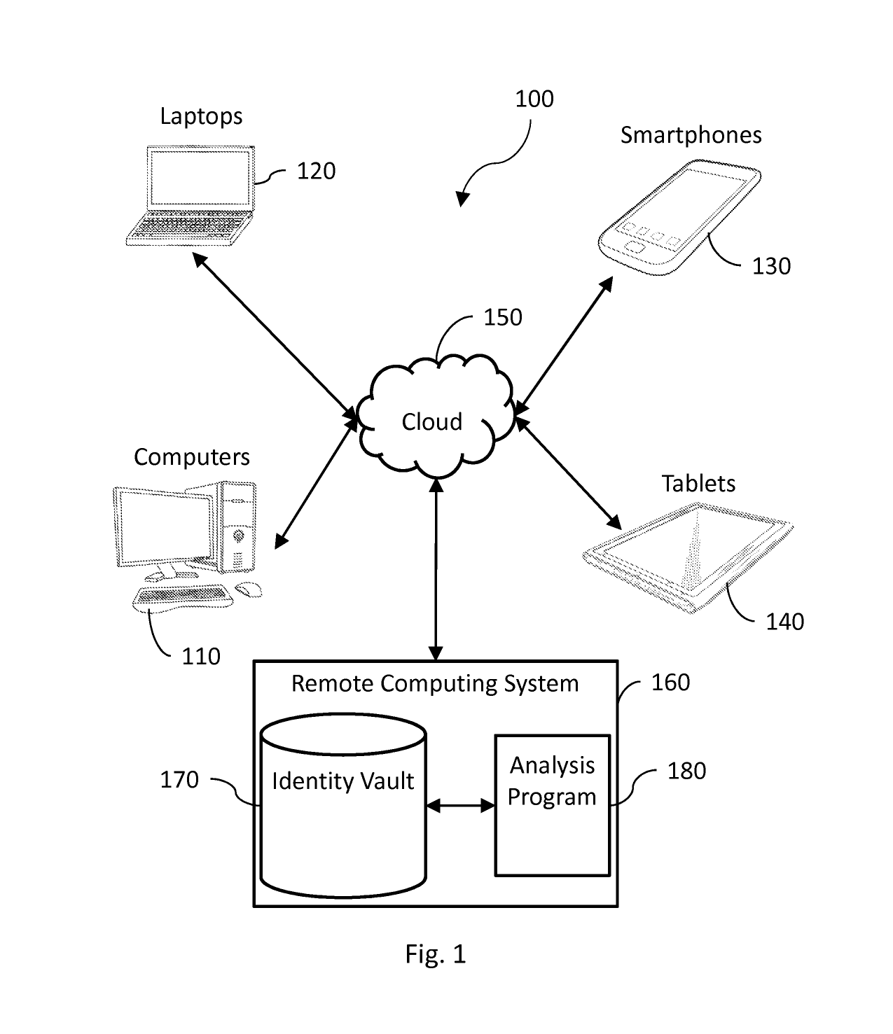

FIG. 1 is an exemplary diagram 100 illustrating aspects of a signature verification system. Users and/or systems can utilize numerous types of security to restrict access to data or execution of computerized processes. Types of security used can include passwords, multi-factor identification, captchas, etc. There can also be biometric based security systems, for example, signature verification, retinal scans, fingerprint scans, voiceprint verification, etc. Systems and features relating to the verification of a user's signature are described herein.

Signatures can be received by one or more devices including, for example, a personal computer 110, a laptop 120, a smartphone 130, a tablet computer 140, etc. Signatures can be entered on such devices in a variety of ways including, for example, by a stylus, by a finger sweeping on a touch sensitive screen, by recording pixels in response to a cursor moving via a mouse, trackpad, or trackball, etc. These recorded signatures can be transmitted via the cloud 150 using a network connection, a wireless connection, etc. to a remote computing system 160. The remote computing system 160 can be responsible for verifying the incoming signature against one or more verified signatures and transmitting the results of the verification back to the originating computer, to a third party computer, or both.

The remote computing system 160 can include, for example, a server, a mainframe, or one or more connected computers. In one implementation, the remote computing system 160 can include an identity vault 170 and an analysis program 180. The identity vault 170 can be a database, a hard drive, a mainframe, etc. that can store signatures associated with a user.

The signatures stored can contain any number and types of coordinates that represent one or more identifying features about the signature or how it was recorded. At its most basic level, signatures can be comprised of pairs of X-Y coordinates corresponding to the pixel positions of points along the path of the strokes used to make the signature. The coordinates can be device-specific, for example, relative to a corner of a screen or other reference point on an input or display device. The coordinates can also be relative to a reference point on the signature itself. For example, if after recording the signature it is determined that the signature is enclosed by a rectangle of 1000×200 pixels, the coordinates can be referenced to pixel positions in that rectangle. Another example can be the referencing of the coordinates to a specific pixel in the signature, for example, the first pixel recorded, the last, or any other.

Beyond the X-Y coordinates associated with a recorded signature, there can be other features associated with each coordinate. Each signature tends to have a unique, or at least a characteristic, pace or time with which the signature is written. For example, a user can typically take 3 seconds to record a signature, 4.2, seconds, etc. Also, the rate at which each part of the signature is written can vary in any number of ways throughout the signature. For example, perhaps the first letter of a signature takes 2.3 seconds to write, whereas the rest of the signature takes 2.0 seconds. This information can be captured by recording, in addition to the X-Y coordinates, the times at which each coordinate was recorded. Again, the times can be absolute, for example, hours, minutes, seconds, or can be relative to the start time, end time, etc. of the signature. Thus, the coordinates can include time entries associated with the pixel positions, where the time entries can correspond to times of recordation of the pixel positions.

Additional features associated with coordinates can also include pressure coordinates (made by a finger or stylus), width coordinates (if the recording software captures data corresponding to the width of a track left by a recording implement), angle coordinates (the angle at which a recording implement is held while making the signature or a recording of a user scribing a signature with a finger or stylus), etc. As can be seen, any number of coordinates can be included as part of the data describing the signature.

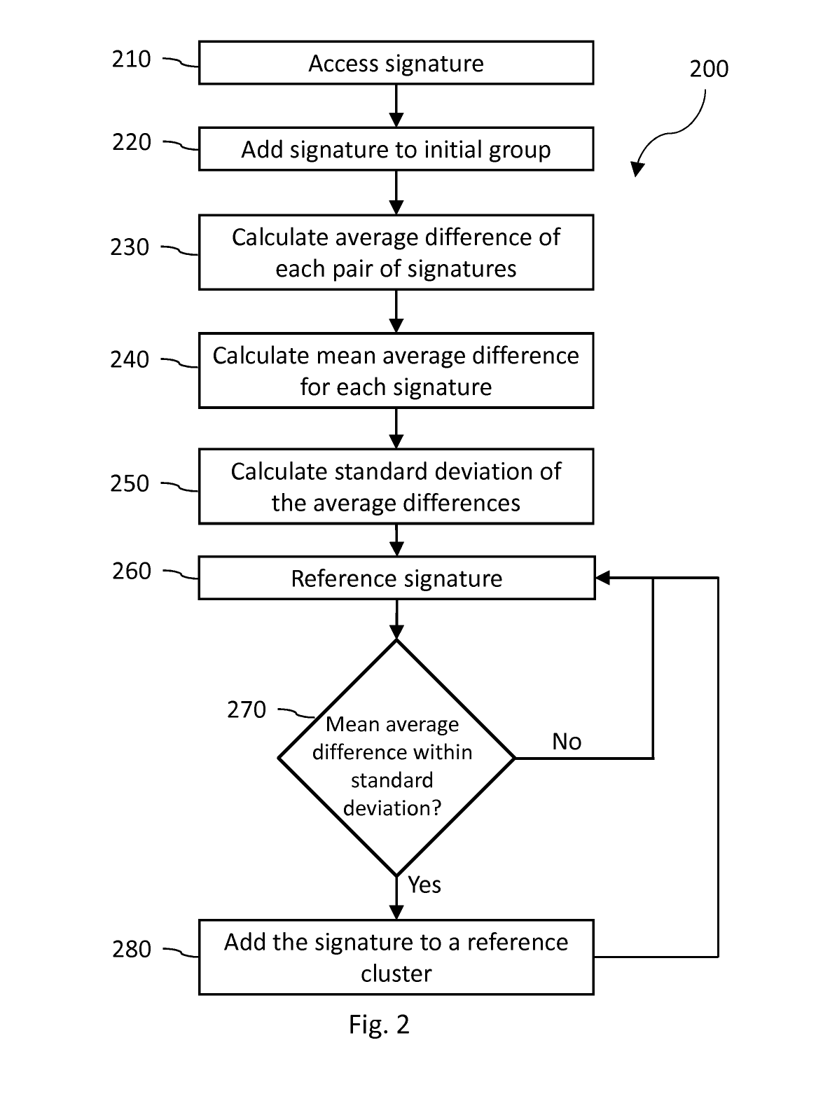

FIG. 2 is an exemplary process flow diagram 200 illustrating the determination of signatures to be added to a reference cluster comprised of signatures. Whenever a person records his/her signature, there can be some natural variation. Accordingly, rather than compare a signature against one particular signature, a signature (herein referred to as a “test signature”) can be compared with a body of signatures. With a sufficiently large and representative group of signatures, statistical methods can be used to determine if the test signature is a verified signature or an unverified signature. Prior to making this determination, an initial group of signatures can be formed to serve as a pool from which representative signatures can be determined.

At 210, a database, for example the identity vault 170, can access data encapsulating an electronic representation of a signature. The electronic representation can be comprised of coordinates that represent the signature, the coordinates including pixel positions on an input device, as described in FIG. 1. The signatures can be stored, for example, in the identity vault 170, one or more databases in the remote computing system, or on another computer system.

At 220, the data can be added to an initial group in the database that contains an arbitrary grouping of signatures. Any number of signatures can be added to the initial group. For example, the initial group can contain 5, 10, 25, 100, etc. signatures. For a first signature, first data encapsulating a first electronic representation of the first signature can be added to the initial group based on a comparison between the first data and a range of acceptable parameters. The range of acceptable parameters can be used to eliminate unrepresentative signatures. If a signature is outside the range of acceptable parameters, the user can receive a warning indicating such. Because verified signatures are not known a priori, the user can also have the option to override the rejection of a signature, thus adding the signature to the initial group. The range of acceptable parameters can be, for example, a comparison with known alphabetic characters, time limits, overall signature size, specified pressure ranges, etc.

For each signature accessed, subsequent to the first, subsequent data encapsulating a subsequent electronic representation of the subsequent signature can be added to the initial group based on a comparison between the subsequent data and a subsequent range of acceptable parameters. The subsequent range of acceptable parameters can be based at least on the initial group. For example, when adding a second signature to the initial group, the first signature can be used as a basis for comparison. One example being, if the second signature took twice as long to sign as the first signature, the user can receive a warning as described above. Other examples can include portions of the second signature being larger or smaller than the first signature, or were signed with quite different pressures, etc. Once there are two or more signatures in the initial group, statistical methods of comparison can be used. For example, averages, standard deviations, etc. of one or more coordinates in the initial group can be determined and used as a basis for comparison with subsequent signatures.

Although the user can verify that the signatures in the initial group are “good” signatures, an analysis program 180 can be used to determine a group of signatures from the initial group that is truly representative of the user's signature. This group is referred to as a reference cluster, which can be a subset of the initial group. The analysis program 180 can determine, based on the coordinates, which data is to be added to the reference cluster in the database. The data added to the reference cluster can then represent a verified signature.

TABLE A
Example calculation of differences between signatures.

| avgDiff | avgDiff | avgDiff | avgDiff | avgDiff |
|---|---|---|---|---|
| Values for | Values for | Values for | Values for | Values for |
| Comparisons | Comparisons | Comparisons | Comparisons | Comparisons |
| With Signature A | With Signature B | With Signature C | With Signature D | With Signature E |
| | B to A | C to A | D to A | E to A |
| A to B | | C to B | D to B | E to B |
| A to C | B to C | | D to C | E to C |
| A to D | B to D | C to D | | E to D |
| A to E | B to E | C to E | D to E | |
| Mean avgDiff | Mean avgDiff | Mean avgDiff | Mean avgDiff | Mean avgDiff |
| Value for A | Value for B | Value for C | Value for D | Value for E |

In one implementation, at 230, an average difference can be calculated for each pair of signatures in the initial group. The average difference is the difference between the coordinates corresponding to the signatures. For example, consider the X coordinate for the signatures in the initial group consisting of five signatures, A through E. The X coordinate for the signatures can be compared to each other as listed in Table A. For each signature, there are N-1 comparisons made, excluding the irrelevant case of comparing a signature to itself. Any subset of a coordinate can be used for the comparisons, for example, the entire range of the X coordinate, a specific fraction of the stored X coordinate, etc. Each comparison is represented above as A to B, A to C, B to C, etc. For example, signature A can be compared with signature B (“A to B”), signature A can be compared with signature C (“A to C”), and so on. While each comparison can be made with all non-like signatures, it can be more computationally efficient to take advantage of the symmetry shown in Table A. By assigning the difference calculated for A to B as also being B to A, the number of comparisons decreases from N(N−1) to N(N−1)/2.

At 240, a mean average difference can be calculated for each signature in the initial group. This value is represented in the last row of Table A and is the average of each of the differences calculated for each signature. In Table A, this is shown by the average taken of each of the differences in each column corresponding to a different signature. In one embodiment, the mean average difference for a signature can be used to determine if the signature is to be added to the reference cluster.

At 250, a standard deviation of the average differences can also be calculated. The standard deviation can represent the scatter, or variation, in the signatures in the initial group. If the signatures are all quite similar, then the standard deviation will be relatively small. If there is a wide range of coordinate values for the signatures in the initial group, then the standard deviation will be comparatively larger. Other methods of characterizing variations of the coordinates in the initial group can be used, for example the variance, skewness, kurtosis, etc.

At 260, each signature in the initial group can be referenced.

At 270, for each signature in the initial group, the mean average difference can be compared with the minimum value and the maximum value in order to determine which signature can be added to the reference cluster. The signature can be added to the reference cluster based on the mean average difference being between a minimum value and a maximum value. In one implementation, the minimum value and the maximum value can be calculated based on the standard deviation of the average differences. For example, if the standard deviation of the initial cluster is SD_{IC} then the minimum value can be the overall average difference for the entire initial cluster minus the standard deviation, i.e., <IC>−SD_{IC}. Similarly, the maximum value can be <IC>+SD_{IC}.

At 280, the analysis program 180 can add the signature to the reference cluster based on the determination performed at 270. Thus, in the example of an initial group of five signatures, approximately 3 signatures can be selected for the reference cluster.

It should be noted that using the standard deviation is not sensitive to the absolute size of the deviation. So regardless of user reproducibility of signatures, the proportion determined to be in the reference cluster will be the same. However, the determination of the minimum value and the maximum value can also be based on other factors. For example, if greater certainty is needed, the range can be tightened. Alternatively, if the range is too restrictive, for example elderly or infirm users which have difficulty making a reproducible signature, an absolute range can be broadened.

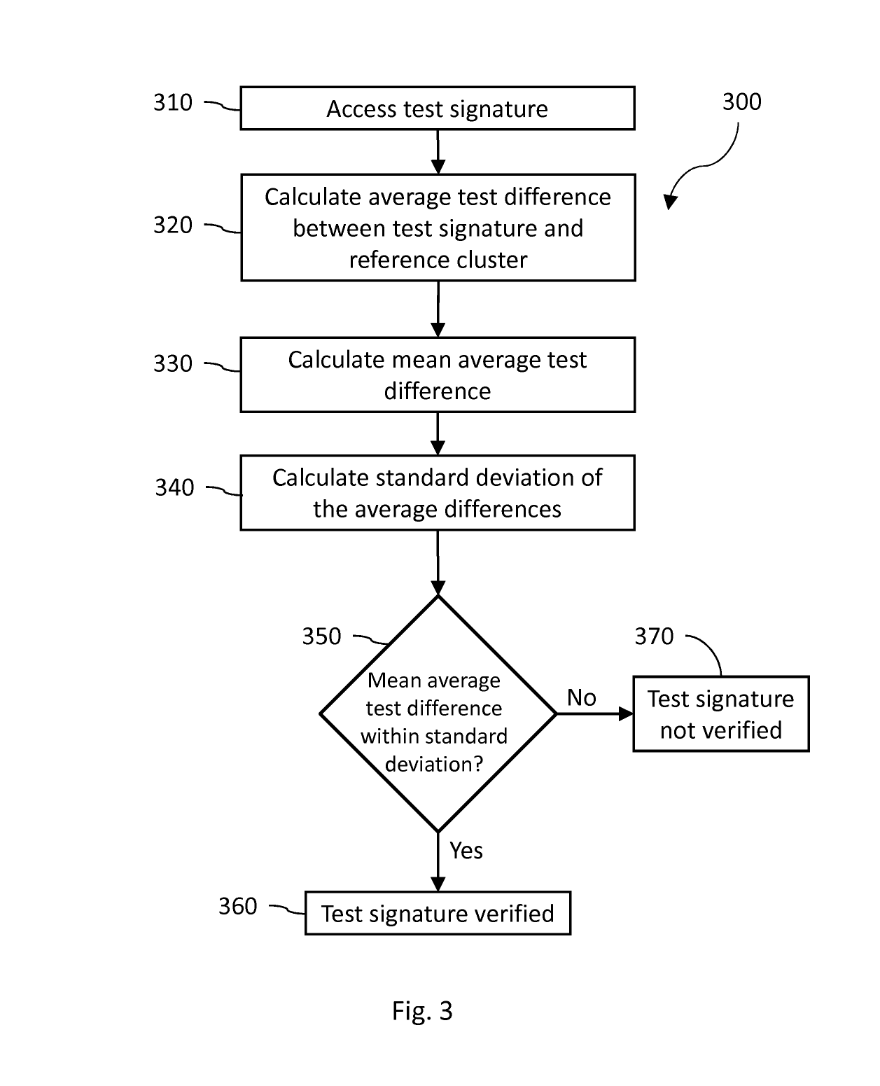

FIG. 3 is an exemplary process flow diagram 300 illustrating verification of a test signature against a reference cluster comprised of signatures. A primary feature of the disclosed subject matter is the ability to verify signatures against a database of approved signatures, for example the reference cluster. Such approval can be utilized in any number of ways, for example, allowing access to devices, permitting transactions, verifying a user's identity, etc.

In one implementation, a test signature can be entered through an input device, or received from another computing system, in a manner similar to the recordation of signatures that were added to the initial group. One exemplary process for verifying a test signature, as shown in FIG. 3, can be similar to that of determining the signatures included in reference cluster that were described in FIG. 2. At 310, test data encapsulating a second electronic representation of a test signature can be accessed by a database. The second electronic representation can be similar to the first electronic representation of the signature collected at 220 in that the second electronic representation can include test coordinates that comprise the second electronic representation. However, the test data need not have a 1:1 correspondence with the data in the reference cluster. For example, if the test cluster contained X-Y coordinate pairs and time entries for coordinates, but the test signature included only X-Y coordinate pairs, then comparison could be made but only using the X-Y coordinate pairs. Accordingly, any number of coordinates can be used for comparison between the test signature and the reference cluster.

TABLE B
Example calculation of test differences between test signatures and
reference cluster.
avgTestDiff Values
for Comparisons
With Test
Signature T
T to B
T to C
T to D
Mean avgTestDiff
Value for T

At 320, for each signature in the reference cluster an average test difference can be calculated. The average test difference is similar to the average difference calculated at 230 but uses the test signature as one of the elements to be compared as shown in Table B. Continuing with the example above, having an initial group of 5 signatures 3 signatures can be added to the reference cluster. Signatures B, C, and D can be added to the reference cluster if, for example, signatures A and E are considered outliers based on the calculation performed at 320. The average test difference can be calculated for each pair of the signatures in the reference cluster, where the average test difference is the difference between the coordinates corresponding to the test signature and each of the signatures in the reference cluster.

At 330, a mean average test difference can be calculated between the test signature and each of the signatures in the reference cluster. This is also shown in Table B and is calculated similarly as described in 240.

At 340, if not already calculated as in 250, the standard deviation of the initial group can be calculated to determine an acceptable range for the coordinates to be compared. Similarly, a maximum value and a minimum value for the mean average test difference can be determined, for example, based on the standard deviation of the initial group, an absolute range, etc. The minimum value can be can be the overall average test difference for the reference cluster minus the standard deviation. Similarly, the maximum value can be the overall average test difference for the reference cluster minus the standard deviation.

At 350, the test signature can be accepted as a verified test signature if the mean average test difference is between the minimum value and the maximum value.

At 360, if verified, results data can be transmitted to a user, a computing system, etc. indicating acceptance or denial of the test signature based on the comparing. The results data can include a graphical display, a change of color of the signature input device, an audio cue, commands for another action to commence, etc.

At 370, if the test signature was not verified, then the user, a computing system, etc. can be notified of the results in a similar manner to that of a verified signature.

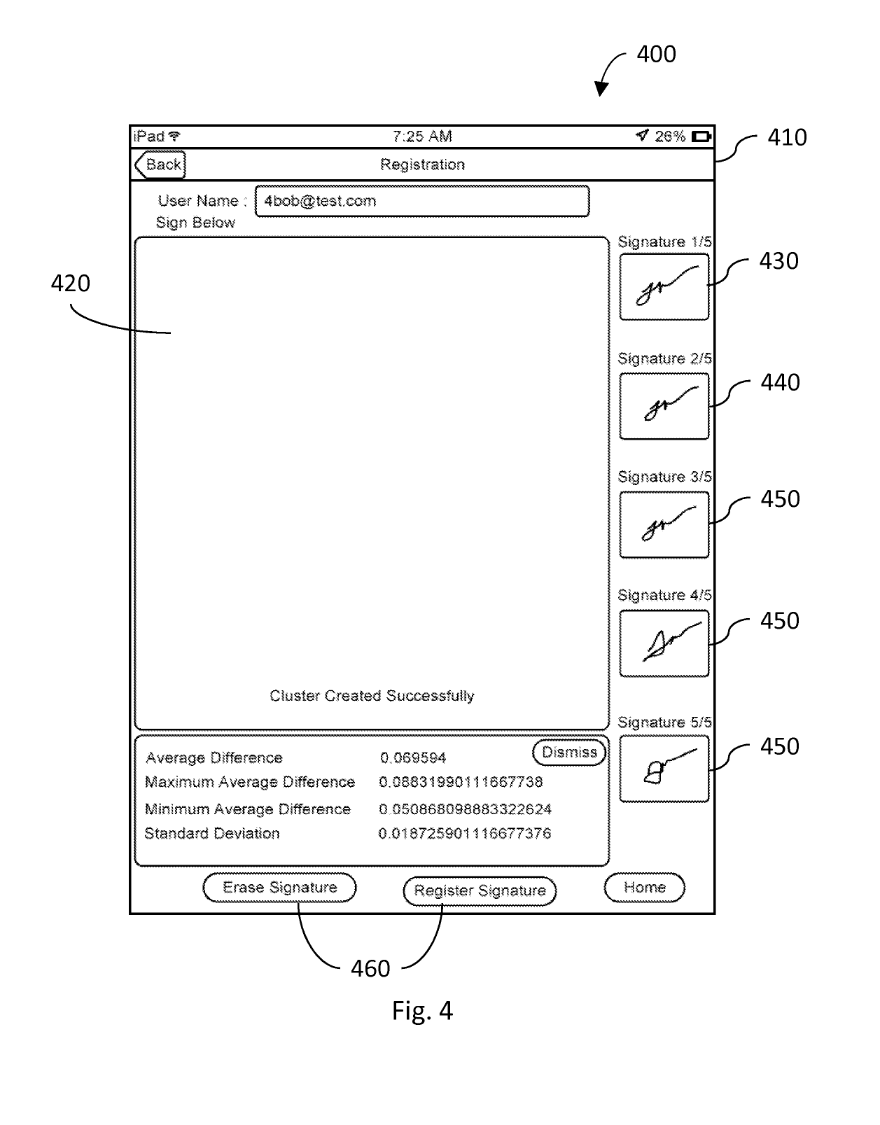

FIG. 4 is an exemplary diagram 400 illustrating a screen capture showing recordation of the signatures. In one example implementation, a graphical user interface 410 can be generated to display a signature field 420 where a user can enter signatures to be added, for example, to the initial group, as a test signature, etc. As discussed above, the coordinates corresponding to a signature can be pixel coordinates based on the signature field. As each signature is entered, a representation of the signature can be displayed in windows 430, 440, and 450. As described above, window 430 can display a first signature, window 440 can display a second signature, and window 450 can display subsequent signatures. Though five signatures are shown, any number of signatures can be displayed. Interface buttons 460 can also be displayed to allow a user to, for example, erase a non-representative signature, register a signature and add it to the initial group, or perform other functions.

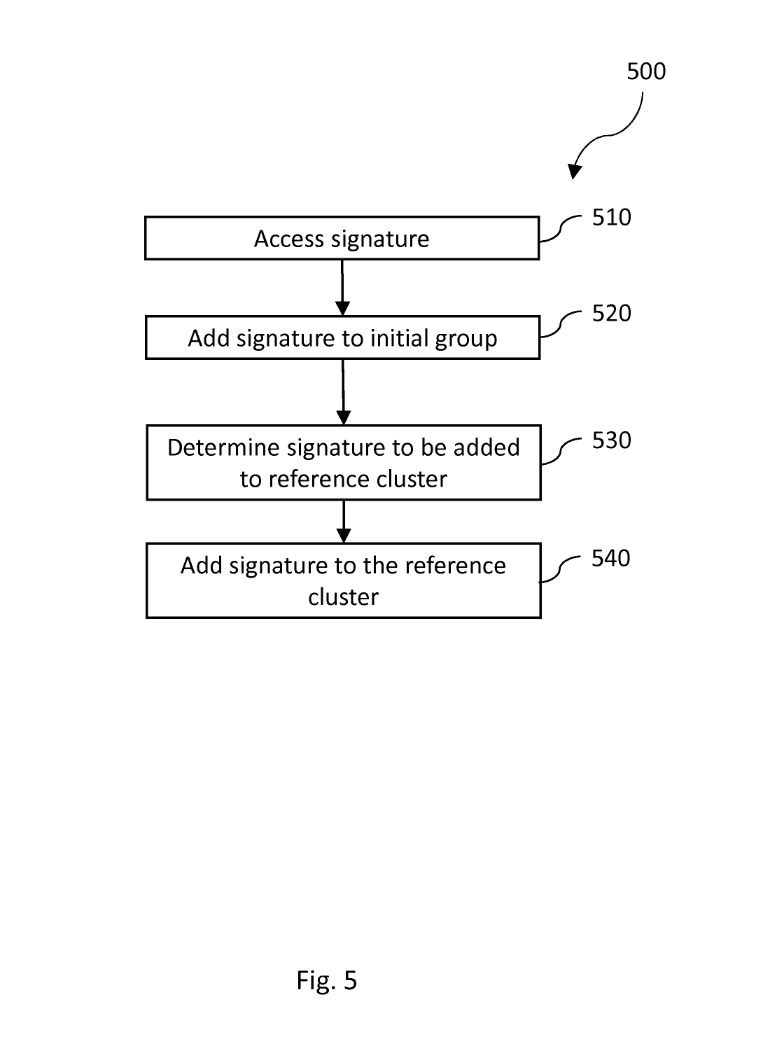

FIG. 5 is an exemplary process flow diagram 500 illustrating the establishment of the reference cluster. The establishment of the reference cluster, as shown in FIG. 5, is similar to the description of same given in FIGS. 1-4.

At 510, a database can access data encapsulating an electronic representation of a signature. The electronic representation can include coordinates that represent the signature. The coordinates can include a plurality of pixel positions on an input device.

At 520, the data from 510 can be added to an initial group in the database.

At 530, an analysis program 180 can determine, based at least on the coordinates, that the data is to be added to a reference cluster in the database. The added data can represent a verified signature. The reference cluster can be a subset of the initial group.

At 540, the data can be added by the analysis program to the reference cluster based on the determination in 530.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A computer program product comprising a non-transitory, machine-readable medium, storing instructions that, when executed by at least one programmable processor, cause the at least one programmable processor to perform operations comprising:
accessing, by a database, data encapsulating an electronic representation of a signature, the electronic representation comprising coordinates that represent the signature, the coordinates comprising a plurality of pixel positions on an input device;
adding the data to an initial group in the database;
determining, by an analysis program and based on the coordinates, that the data is to be added to a reference cluster in the database, the data added representing a verified signature, the reference cluster being a subset of the initial group; and
adding, by the analysis program, the data to the reference cluster based on the determining.

2. The computer program product of claim 1, further comprising:
accessing, by the database, test data encapsulating a second electronic representation of a test signature, the second electronic representation comprising test coordinates that represent the test signature;
comparing, by the database, the test data to the reference cluster; and
transmitting, by the database, results data indicating acceptance or denial of the test signature based on the comparing.

3. The computer program product of claim 1, the determining further comprising:
for a first signature, adding first data encapsulating a first electronic representation of the first signature to the initial group based on a comparison between the first data and a range of acceptable parameters; and
for each signature accessed, subsequent to the first, adding subsequent data encapsulating a subsequent electronic representation of the subsequent signature to the initial group based on a comparison between the subsequent data and a subsequent range of acceptable parameters, the subsequent range of acceptable parameters based at least on the initial group.

4. The computer program product of claim 1, wherein the coordinates further comprise a plurality of time entries associated with the plurality of pixel positions, wherein the plurality of time entries correspond to times of recordation of the plurality of pixel positions.

5. The computer program product of claim 1, the determining further comprising:
calculating an average difference for each pair of the signatures in the initial group, wherein the average difference is the difference between the coordinates corresponding to the signatures;
calculating a mean average difference for each signature in the initial group;
calculating a standard deviation of the average differences;
calculating, based on the standard deviation of the average differences, a minimum value and a maximum value; and
adding the signature to the reference cluster based on the mean average difference being between the minimum value and the maximum value.

6. The computer program product of claim 5, further comprising:
accessing, by the database, test data encapsulating a second electronic representation of a test signature, the second electronic representation comprising test coordinates that represent the test signature;
calculating an average test difference for each signature in the reference cluster, wherein the average test difference is a difference between the coordinates corresponding to the test signature and each of the signatures in the reference cluster;
calculating a mean average test difference between the test signature and each of the signatures in the reference cluster;
accepting the test signature as a verified test signature if the mean average test difference is between the minimum value and the maximum value; and
transmitting results data indicating acceptance or denial of the test signature based on the comparing.

7. A system comprising:
at least one programmable data processor; and
memory storing instructions which, when executed by the at least one programmable data processor, result in operations comprising:
accessing, by a database, data encapsulating an electronic representation of a signature, the electronic representation comprising coordinates that represent the signature, the coordinates comprising a plurality of pixel positions on an input device; adding the data to an initial group in the database;
determining, by an analysis program and based on the coordinates, that the data is to be added to a reference cluster in the database, the data added representing a verified signature, the reference cluster being a subset of the initial group; and
adding, by the analysis program, the data to the reference cluster based on the determining.

8. The system of claim 7, further comprising:
accessing, by the database, test data encapsulating a second electronic representation of a test signature, the second electronic representation comprising test coordinates that represent the test signature;
comparing, by the database, the test data to the reference cluster; and
transmitting, by the database, results data indicating acceptance or denial of the test signature based on the comparing.

9. The system of claim 7, the determining further comprising:
for a first signature, adding first data encapsulating a first electronic representation of the first signature to the initial group based on a comparison between the first data and a range of acceptable parameters; and
for each signature accessed, subsequent to the first, adding subsequent data encapsulating a subsequent electronic representation of the subsequent signature to the initial group based on a comparison between the subsequent data and a subsequent range of acceptable parameters, the subsequent range of acceptable parameters based at least on the initial group.

10. The system of claim 7, wherein the coordinates further comprise a plurality of time entries associated with the plurality of pixel positions, wherein the plurality of time entries correspond to times of recordation of the plurality of pixel positions.

11. The system of claim 7, the determining further comprising:
calculating an average difference for each pair of the signatures in the initial group, wherein the average difference is the difference between the coordinates corresponding to the signatures;
calculating a mean average difference for each signature in the initial group;
calculating a standard deviation of the average differences;
calculating, based on the standard deviation of the average differences, a minimum value and a maximum value; and
adding the signature to the reference cluster based on the mean average difference being between the minimum value and the maximum value.

12. The system of claim 11, further comprising:
accessing, by the database, test data encapsulating a second electronic representation of a test signature, the second electronic representation comprising test coordinates that represent the test signature;
calculating an average test difference for each signature in the reference cluster, wherein the average test difference is a difference between the coordinates corresponding to the test signature and each of the signatures in the reference cluster;
calculating a mean average test difference between the test signature and each of the signatures in the reference cluster;
accepting the test signature as a verified test signature if the mean average test difference is between the minimum value and the maximum value; and
transmitting results data indicating acceptance or denial of the test signature based on the comparing.

13. A computer-implemented method comprising:
accessing, by a database, data encapsulating an electronic representation of a signature, the electronic representation comprising coordinates that represent the signature, the coordinates comprising a plurality of pixel positions on an input device; adding the data to an initial group in the database;
determining, by an analysis program and based on the coordinates, that the data is to be added to a reference cluster in the database, the data added representing a verified signature, the reference cluster being a subset of the initial group; and
adding, by the analysis program, the data to the reference cluster based on the determining.

14. The computer-implemented method of claim 13, further comprising:
accessing, by the database, test data encapsulating a second electronic representation of a test signature, the second electronic representation comprising test coordinates that represent the test signature;
comparing, by the database, the test data to the reference cluster; and
transmitting, by the database, results data indicating acceptance or denial of the test signature based on the comparing.

15. The computer-implemented method of claim 13, the determining further comprising:
for a first signature, adding first data encapsulating a first electronic representation of the first signature to the initial group based on a comparison between the first data and a range of acceptable parameters; and
for each signature accessed, subsequent to the first, adding subsequent data encapsulating a subsequent electronic representation of the subsequent signature to the initial group based on a comparison between the subsequent data and a subsequent range of acceptable parameters, the subsequent range of acceptable parameters based at least on the initial group.

16. The computer-implemented method of claim 13, wherein the coordinates further comprise a plurality of time entries associated with the plurality of pixel positions, wherein the plurality of time entries correspond to times of recordation of the plurality of pixel positions.

17. The computer-implemented method of claim 13, the determining further comprising:
calculating an average difference for each pair of the signatures in the initial group, wherein the average difference is the difference between the coordinates corresponding to the signatures;
calculating a mean average difference for each signature in the initial group;
calculating a standard deviation of the average differences;
calculating, based on the standard deviation of the average differences, a minimum value and a maximum value; and
adding the signature to the reference cluster based on the mean average difference being between the minimum value and the maximum value.

18. The computer-implemented method of claim 17, further comprising:
accessing, by the database, test data encapsulating a second electronic representation of a test signature, the second electronic representation comprising test coordinates that represent the test signature;
calculating an average test difference for each signature in the reference cluster, wherein the average test difference is a difference between the coordinates corresponding to the test signature and each of the signatures in the reference cluster;
calculating a mean average test difference between the test signature and each of the signatures in the reference cluster;
accepting the test signature as a verified test signature if the mean average test difference is between the minimum value and the maximum value; and
transmitting results data indicating acceptance or denial of the test signature based on the comparing.
